(19) United States
(12) Patent Application Publication
(10) Pub. No.: US 2011/0019279 A1
(43) Pub. Date: Jan. 27, 2011

(54) LIGHT DIFFUSING FILM AND PROCESS FOR PRODUCING THE LIGHT DIFFUSING FILM

(75) Inventors: Hideyuki Yonezawa, Osaka (JP); Minoru Miyatake, Osaka (JP); Akinori Nishimura, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/921,047

(22) PCT Filed: Dec. 8, 2008
(86) PCT No.: PCT/JP2008/072231

§ 371 Date: Sep. 3, 2010

(30) Foreign Application Priority Data
Mar. 12, 2008 (JP) 2008-062853

(51) Int. Cl. G02B 5/02; B29D 11/00

(52) U.S. Cl. 359/599; 264/1.6

(57) ABSTRACT

A light diffusing film having superior productivity can be obtained by using very short fibers as a substitute for conventional spherical fine particles as light diffusing material. It is possible to mass-produce very short fibers at low cost, for example, by cutting fibers. Further, it is relatively easy to obtain very short fibers with a narrow fiber length distribution. The use of this makes it possible to carry out more highly sophisticated optical design of light diffusing films.

### BACKGROUND OF THE INVENTION

1. Field of the Invention

The present invention relates to a process for producing a light diffusing film in which a plurality of very short fibers are dispersed in a film made of a translucent resin.

2. Description of Related Art

Light diffusing films are used for various displays for the purpose of making light intensity distribution of light from a light source uniform and avoiding unevenness in brightness of screens. Conventionally, films in which spherical fine particles with small and large diameter are dispersed in each film made of a translucent resin as light diffusing material are known as light diffusing films (Japanese Patent Application Laid-open Publication No. JP 2003-43218 A). Such light diffusing films are capable of obtaining desired light diffusing characteristics by adjusting the refractive index or the size of the spherical fine particles.

However, such conventional light diffusing films had disadvantages of high cost and poor productivity because as the particle size of spherical fine particles used for these light diffusing films became smaller, it became more difficult to mass-produce these films, resulting in high cost. Therefore, novel light diffusing films which solve such problems have been demanded.

### SUMMARY OF THE INVENTION

It is an object of the present invention to provide a light diffusing film which is easy to mass-produce its material at low cost and has superior productivity, and a process for producing the light diffusing film.

It has revealed that as a result of studies of inventors of the present invention, a light diffusing film having superior productivity and a process for producing thereof can be obtained by using very short fibers.

The summary of the present invention is as follows:

In a first preferred embodiment, a light diffusing film according to the present invention comprises: a film made of a translucent resin; and a plurality of very short fibers dispersed in the film made of a translucent resin, wherein an average refractive index n_{A} of the translucent resin is different from an average refractive index n_{B} of the very short fibers when the average refractive index n_{A} of the translucent resin is defined as (extraordinary refractive index+2×ordinary refractive index)/3 and the average refractive index n_{B} of the very short fibers is defined as (refractive index in the direction of a major axis+2×refractive index in the direction of a minor axis)/3. The major axis direction of the very short fibers is a fiber axis direction and the minor axis direction of the very short fibers is a direction orthogonal to the fiber axis direction.

In a second preferred embodiment of the light diffusing film according to the present invention, the average refractive index n_{A} of the translucent resin is 1.3 to 1.7 and the average refractive index n_{B} of the very short fibers is 1.4 to 1.6, and an absolute value of the difference between the average refractive index n_{A} of the translucent resin and the average refractive index n_{B} of the very short fibers, |n_{A}−n_{B}| is 0.005 to 0.15.

In a third preferred embodiment, the light diffusing film according to the present invention comprises: a film made of a translucent resin; and a plurality of very short fibers dispersed in the film made of a translucent resin, each of which has a first refractive index region and a second refractive index region provided within the first refractive index region, wherein an average refractive index n_{A} of the translucent resin is different from an average refractive index n_{B2} of the very short fibers in the second refractive index region when the average refractive index n_{B2} of the very short fibers in the second refractive index region is defined as (refractive index in the direction of a major axis+2×refractive index in the direction of a minor axis)/3. The major axis direction of the very short fibers in the second refractive index region is a direction of a fiber axis in the same region and the minor axis direction is a direction to be orthogonal to the direction of the fiber axis.

In a fourth preferred embodiment of the light diffusing film according to the present invention, an average refractive index n_{A} of the translucent resin is 1.3 to 1.7 and an absolute value of the difference between the average refractive index n_{A} of the transparent resin and an average refractive index n_{B2} of the very short fibers in the second refractive index region, |n_{A}−n_{B2}| is 0.01 to 0.15.

In a fifth preferred embodiment of the light diffusing film according to the present invention, an average refractive index n_{A} of the translucent resin, an average refractive index n_{B1} of the very short fibers in the first refractive index region, and an average refractive index n_{B2} of the very short fibers in the second refractive index region satisfies the relationship: n_{A}<n_{B1}<n_{B2} or n_{B2}<n_{B1}<n_{A} when the average refractive index n_{B1} of the very short fibers in the first refractive index region is defined as (refractive index in the direction of a major axis+2×refractive index in the direction of a minor axis)/3. The major axis direction of the very short fibers in the first refractive index region is a direction of the fiber axis in the same region and the minor axis direction of the very short fibers is a direction orthogonal to the direction of the fiber axis.

In a sixth preferred embodiment, the light diffusing film according to the present invention comprises: a film made of a translucent resin; a plurality of very short fibers dispersed in the film made of a translucent resin; and a plurality of spherical fine particles dispersed in the film made of a translucent resin, wherein an average refractive index of the translucent resin is different from an average refractive index of the very short fibers and a refractive index of the spherical fine particles. The average refractive index of the very short fibers and the refractive index of the spherical fine particles may be identical or different.

In a seventh preferred embodiment, a process for producing the aforementioned light diffusing film according to the present invention comprises the steps of: A) dispersing a plurality of very short fibers obtained by cutting fibers in a liquid material which may form a film made of a translucent resin to obtain a dispersion liquid; and B) casting the dispersion liquid obtained in the step A in a film and solidifying or curing a cast layer thereof to obtain a light diffusing film.

### ADVANTAGE OF THE INVENTION

The present invention makes it possible to realize a light diffusing film having superior productivity and a process for producing the same.

### DESCRIPTION OF THE PREFERRED EMBODIMENTS

As a result of a careful study conducted by the inventors of the present invention to resolve the above-mentioned problems, it has revealed that a light diffusing film having superior productivity can be obtained by using very short fibers as a substitute for spherical fine particles that have been used for conventional light diffusing films as light diffusing material.

It is possible to mass-produce very short fibers to be used in the present invention at low cost, for example, by cutting fibers. Although it was conventionally difficult to obtain spherical fine particles with a narrow particle size distribution, it is relatively easy to obtain very short fibers with a narrow fiber length distribution, for example, by appropriately adjusting the cutting width of the fibers. The use of this makes it possible to carry out more highly sophisticated optical design of light diffusing films.

### [Light Diffusing Film]

The light diffusing film to be used in the present invention comprises: a film made of a translucent resin; and a plurality of very short fibers dispersed in the film made of a translucent resin, wherein an average refractive index of the translucent resin is different from an average refractive index of the very short fibers. Very short fibers are used because: (1) the very short fibers are convenient to achieve a three-dimensional random distribution of fiber orientation within the thin light diffusing film; and (2) the light diffusing efficiency of the light diffusing film is superior because of having several end surfaces of the fibers. In this light diffusing film, it is possible to effectively produce light diffusing films because it is possible to mass-produce very short fibers at low cost. Further, such a light diffusing film enables highly sophisticated optical design because it is possible to minimize the fiber length distribution of the very short fibers as narrow as possible.

The light diffusing film of the present invention can emit diffusion light by refracting incident light at an interface between the very short fibers and the translucent resin. Since the light diffusing film can emit diffusion light, generally, the light diffusing film visually looks cloudy.

The very short fibers are preferably dispersed in such a state that the distribution of orientation of the very short fibers (the distribution of orientation of a fiber axis of the very short fibers) is random in three dimensions. However, the number of the very short fibers oriented in a direction perpendicular to the plane of the film may be relatively small as long as the orientation of the very short fibers is random in the plane of the film. When the distribution of orientation of the very short fibers is closer to random in three dimensions, the more it is possible to diffuse incident light in all directions all-around.

The degree of light diffusion of the light diffusing film of the present invention is determined by an absolute value of the difference between an average refractive index n_{A} of the translucent resin and an average refractive index n_{B} of the very short fibers, |n_{A}−n_{B}|. |n_{A}−n_{B}| is preferably 0.005 to 0.15, more preferably 0.01 to 0.10.

The haze value of the light diffusing film of the present invention is appropriately adjusted by adjusting the amount of the very short fibers to be added and typically has a haze of 10 to 90%. The amount of the very short fibers to be added is preferably 10 to 50 wt %, more preferably 15 to 40 wt %, with respect to the total weight of the light diffusing film.

The thickness of the light diffusing film of the present invention is preferably 5 to 300 μm, more preferably 10 to 200 μm.

As shown in FIG. 1 (a), in one embodiment, a light diffusing film 10 of the present invention comprises: a film made of a translucent resin 12; and a plurality of very short fibers 11 dispersed in the film as light diffusing material. The light diffusing film 10 with such a configuration is at low cost and excellent in productivity.

As shown in FIG. 1 (b), in another embodiment, a light diffusing film 20 of the present invention comprises: a film made of a translucent resin 23; a plurality of spherical fine particles 21 dispersed in the film of the translucent resin 23 as light diffusing material; and a plurality of very short fibers 22 dispersed in the film made of the translucent resin 23 as light diffusing material. An average refractive index of the translucent resin 23 (a portion including no very short fibers) is different from an average refractive index of the very short fibers 22 and an average refractive index of the spherical fine particles 21. In this case, the average refractive index of the very short fibers 22 may be identical to or different from the refractive index of the spherical fine particles 21. In the light diffusing film 20 of such a configuration, the very short fibers 22 are typically used instead of spherical fine particles with a small particle size which was difficult to be used due to high cost. In this case, the diameter of the very short fibers 22 corresponds to the diameter of the spherical fine particles with small particle size. Since the particle size distribution substantially has two peaks (the diameter of the very short fibers 22 and the diameter of the spherical fine particles 21) because of this configuration, it is possible to carry out more highly sophisticated optical design. In addition, the light diffusing film 20 is less expensive and has more superior productivity than the film using spherical fine particles having small particle size.

### [Very Short Fibers]

The very short fibers to be used in the present invention can be typically obtained by cutting fibers. In the present invention, the word “very short fiber” refers to one having a fiber length of 1 mm or less, and the word “fiber” refers to one having a fiber length larger than 1 mm. The fiber length of the very short fibers to be used in the present invention is preferably 2 μm to 500 μm, more preferably 10 μm to 100 μm.

The cross-sectional shape of the very short fibers to be used in the present invention perpendicular to a fiber axis is not particularly limited, and may be a circle, a polygon such as a triangle or a quadrangle, or a polygonal shape with rounded corners. The diameter of the very short fibers is preferably 2 μm to 50 μm, more preferably 2 μm to 30 μm. It is to be noted that when the cross-sectional shape of the very short fibers is not a circle, the longest span between two points in their cross section is defined as a diameter.

The material of the very short fibers to be used in the present invention is not particularly limited, but a polymer material is suitable from the viewpoint of excellent workability, particularly, the polymer material that is excellent in translucency and no colored is preferable. Examples of such a polymer material include olefin-based polymers, vinyl alcohol-based polymers, (meth)acrylic-based polymers, ester-based polymers, styrene-based polymers, imide-based polymers, amide-based polymers, liquid-crystal polymers, and blended polymers of two or more of these polymers. Among them, olefin-based polymers, vinyl alcohol-based polymers, and blended polymers of two or more of these polymers are preferably used.

The very short fibers to be used in the present invention may be composed of one type of refractive index region or may be composed of two types of refractive index regions.

In the case where the very short fibers composed of one kind of refractive index region are used, the very short fibers preferably have an average refractive index n_{B} of 1.4 to 1.6. If necessary, the average refractive index n_{B}of the very short fibers can be increased or decreased by changing the kind of organic group to be introduced into the very short fibers and/or the amount of an organic group contained in the very short fibers. For example, the refractive index of the very short fibers can be increased by introducing a cyclic aromatic group (e.g., a phenyl group) into the very short fibers. On the other hand, the refractive index of the very short fibers can be decreased by introducing an aliphatic group (e.g., a methyl group) into the very short fibers.

Examples of the aforementioned very short fibers having two types of refractive index regions include so-called “core-sheath structured” very short fibers 30 with a second refractive index region 32 provided within a first refractive index region 31 shown in FIG. 2 (a) and very short fibers 40 with two or more second refractive index regions 42 within the first refractive index regions 41 having a so-called island structure shown in FIG. 2 (b).

Although both the very short fiber 30 shown in FIG. 2(a) and the very short fiber 40 shown in FIG. 2(b) are composed of only the first and second refractive index regions, the very short fibers to be used in the present invention may have a third refractive index region (not shown) made of any material and/or an optically-isotropic region (not shown) made of any material. Further, the second refractive index region of the very short fiber shown in FIG. 2(a) and the second refractive index regions of the very short fiber shown in FIG. 2(b) are all cylindrical, but the shape of the second refractive index region is not particularly limited, and may be a polygonal prism such as a triangular prism or a quadrangular prism or a polygonal prism with rounded corners. Further, the second refractive index regions do not always need to be evenly distributed within the first refractive index region, and may be unevenly distributed within the first refractive index region.

In a case where the light diffusing film according to the present invention uses very short fibers each having a first refractive index region and a second refractive index region provided within the first refractive index region, the average refractive index n_{A} of the translucent resin, the average refractive index n_{B1} of the first refractive index region, and the average refractive index n_{B2} of the second refractive index region satisfy the relationship: n_{A}<n_{B1}<n_{B2} or n_{B2}<n_{B1}<n_{A}. In the case of such a light diffusing film in which the average refractive index is changed stepwise, the difference in refractive index at an interface between two members is small, and therefore interfacial reflection occurring at the interface between the translucent resin and the very short fibers can be reduced so that backscattering may be reduced.

The absolute value of the difference between the average refractive index n_{A}of the translucent resin and the second refractive index n_{B2} of the very short fibers in the second refractive index region, |n_{A}−n_{B2} is preferably 0.01 to 0.15, more preferably 0.02 to 0.10. This makes it possible to obtain emitting light having wide diffusion properties and inhibit the backscattering at the same time.

### [Translucent Resin Film]

The translucent resin film to be used in the present invention is a film obtained by molding a translucent rein into a film. In the translucent resin film, a plurality of very short fibers are dispersed. The transmittance of the translucent resin at a wavelength of 546 nm is preferably 50% or higher, more preferably 70% or higher.

The translucent resin to be used in the present invention can be made of any material excellent in transparency as long as a plurality of very short fibers can be immobilized therein in a dispersed state. Examples of such a material for forming a translucent resin include UV-curable resins, cellulose-based polymers, and norbornene-based polymers. The translucent resin is preferably made of an energy-ray curable resin, more preferably of a UV-curable resin. An energy-ray curable resin, especially a UV-curable resin can be rapidly molded into a film, which contributes to productivity growth.

The average refractive index n_{A} of the translucent resin is preferably 1.3 to 1.7, more preferably 1.4 to 1.6. If necessary, the average refractive index n_{A} of the translucent resin can be appropriately adjusted in the same manner as the aforementioned adjusting method of the refractive index of the very short fibers.

The translucent resin to be used in the present invention is preferably an optically-isotropic resin hardly having refractive index anisotropy. In the present invention, the word “optically-isotropic resin” refers to a resin whose birefringence (i.e., the difference between an extraordinary refractive index and an ordinary refractive index) is less than 0.001.

It is preferred that the translucent resin is completely embedded in the light diffusing material such as very short fibers. However, some of the light diffusing material may be exposed due to incomplete embedding as long as they are immobilized.

The translucent resin film may contain any additive. Examples of such an additive include surfactants, cross-linking agents, antioxidants, and antistatic agents. The amount of the additive contained in the translucent resin film is not particularly limited, but is usually 5 wt % or less with respect to the total weight of the light diffusing film.

### [Production Process of the Present Invention]

A process for producing a light diffusing film according to the present invention comprises the steps of: A) dispersing a plurality of very short fibers obtained by cutting fibers in a liquid material, from which a film made of a translucent resin can be formed, to obtain a dispersion liquid; and B) casting the dispersion liquid obtained in the step A in a film to form a cast layer and then solidifying or curing the cast layer to obtain a light diffusing film. If necessary, the process for producing a light diffusing film according to the present invention may further comprise another step in addition to the steps A and B.

### [Step A]

The step A is a step of dispersing a plurality of very short fibers obtained by cutting fibers in a liquid material, from which a film made of a translucent resin can be formed, to obtain a dispersion liquid.

The unstretched fiber can be produced by extruding a melted polymer from a spinning nozzle. A fiber having two or more types of birefringent regions can be produced by extruding, for example, two different melted polymer materials from a nozzle for sea-island composite fiber spinning. Alternatively, a fiber having two or more types of birefringent regions may be produced by coating the surface of a single-structure fiber with another material.

A method for obtaining very short fibers by cutting fibers is not particularly limited. For example, a fiber bundle obtained by arranging a plurality of fibers in parallel with each other may be cut by a cutting blade.

Alternatively, a method described in Japanese Patent Application Laid-Open Publication No. JP 2005-113291 A may be employed. More specifically, a fiber bundle is impregnated with a liquid or gaseous embedding material, and then the embedding material is solidified by decreasing the temperature to integrate the fiber bundle with the embedding material to form a single unit, and then the end face of the single unit is cutting-worked at a low temperature, and then the embedding material is removed by increasing the temperature to obtain very short fibers having a length of about 0.005 mm to 1 mm.

Alternatively, a method described in Japanese Patent Application Laid-open Publication No. JP 2005-126854 A may be employed. More specifically, a fiber bundle is impregnated with a liquid or gaseous embedding material, and then the embedding material is solidified by decreasing the temperature to integrate the fiber bundle with the embedding material to form a single unit, and then the end faces of the thus prepared two or more single units are planed at a low temperature, and then the embedding material is removed by increasing the temperature to obtain very short fibers having a length of about 0.005 mm to 1 mm.

Alternatively, a method described in Japanese Patent Application Laid-Open Publication No. JP 2005-139573 A may be employed. More specifically, a plurality of fiber bundles arranged so as not to come into contact with each other are impregnated with a liquid or gaseous embedding material, and then the embedding material is solidified by decreasing the temperature to integrate the fiber bundles with the embedding material to form a single unit, and then the end face of the single unit is cutting-worked at a low temperature, and then the embedding material is removed by increasing the temperature to obtain very short fibers having a length of about 0.005 mm to 1 mm.

The liquid material for forming a translucent resin film is not particularly limited. For example, a solution obtained by dissolving a translucent resin in a solvent or a solvent-free or solvent-containing energy-ray curable resin liquid is used.

A method for preparing the dispersion liquid is not particularly limited. For example, the dispersion liquid may be prepared by adding the above-described liquid material to the very short fibers placed in a container little by little under stirring or by adding the very short fibers to the above-described liquid material placed in a container little by little under stirring.

### [Step B]

The step B is a step of casting the dispersion liquid in a film to form a cast layer and then solidifying or curing the cast layer to obtain a light diffusing film.

A method for casting the dispersion liquid in a film is not particularly limited, and a coating method using any coater may be employed. Examples of a coater used in a coating method include a slot orifice coater, a die coater, a bar coater, and a curtain coater.

In the step B, the cast layer is solidified or cured by any method. In the present invention, the word “solidified” means that a softened or melted resin (polymer) is solidified by cooling or a resin (polymer) dissolved in a solvent is solidified by removing the solvent, and the word “cured” means that a resin (polymer) is cross-linked by exposure to heat, catalyst, light, or radiation and therefore becomes hardly soluble or meltable. The conditions for solidifying or curing are appropriately determined depending on the kind of translucent resin used. In a case where a UV-curable resin is used as the translucent resin, the conditions for curing the UV-curable resin are to expose it to UV light at an illuminance of preferably 5 mW/cm² to 1,000 mW/cm² so that the integral amount of light becomes preferably 100 mJ/cm² to 5,000 mJ/cm².

### [Usage of Light Diffusing Film]

The light diffusing film according to the present invention is suitable for use in liquid-crystal panels for, for example, computers, copiers, mobile phones, watches, digital cameras, portable information terminals, portable game machines, video cameras, TV sets, microwave ovens, car navigation systems, car audio systems, monitors for stores, surveillance monitors, and medical monitors.

### EXAMPLES

### Example 1

An ethylene vinyl alcohol copolymer (produced by Nippon Synthetic Chemical Industry Co., Ltd. Product Name: “Soarnol DC321B,” melting point: 181° C.) was fused at 270° C. and then was charged into a nozzle for single-structure fiber spinning to obtain a spinning filament with a diameter of 30 μm by spinning the copolymer at a spinning rate of 600 m/minute. This spinning filament was stretched 4 times as long as the original length in warm water at 60° C. to obtain fibers with a diameter of 15 μm.

The aforementioned long fibers are aligned to form a fiber bundle and then the fiber bundle was cut by a machining blade by fixing a polyvinyl alcohol resin to be embedded therein. Subsequently, a polyvinyl alcohol resin was dissolved in hot water to be removed to obtain the aforementioned very short fibers with a fiber length of 30 μm.

A number of the above-mentioned fibers were prepared. And then the fibers were dispersed into a polyester acrylate-base ultraviolet curable resin liquid (produced by Sartomer Company Inc., Product Name: “CN2273) to prepare a dispersion liquid. This dispersion liquid was cast by flowing on the surface of a polyethylene terephthalate film to form a cast layer. Subsequently, the cast layer was cured by irradiating ultraviolet rays (illuminance=40 mW/cm², amount of integrating light: 1,000 mJ/cm²) and then the polyethylene terephthalate film was peeled off to prepare a light diffusing film with a thickness of 150 μm. The mixed quantity of the very short fibers was 30 weight parts with respect to the total amount of light diffusing film. The average refractive index of each component and diffusing characteristics of the light diffusing film prepared in such a manner were as shown in Table 1.

### Example 2

An ethylene vinyl alcohol copolymer (produced by Nippon Synthetic Chemical Industry Co., Ltd. Product Name: “Soarnol DC321B,” melting point: 181° C.) and an ethylene propylene copolymer of excessive propylene (produced by Japan Polypropylene Corporation, Product Name “OX1066A”, melting point: 138° C.) were respectively fused at 270° C. and 230° C. and then were charged into a nozzle for sea-island composite fiber spinning (island number per fiber cross section: 37) to obtain a spinning filament with a diameter of 30 μm by spinning these copolymers at a spinning rate of 600 m/minute.

This spinning filament was stretched 4 times as long as the original length in warm water at 60° C. to obtain fibers with a diameter of 15 μm. When the cross section surfaces of the fibers were observed with an electron microscope, it was confirmed that a sea-island structure was configured wherein a columnar (diameter of its cross section: approximately 1 μm) second refractive index region (island portion) composed of an ethylene vinyl alcohol copolymer was distributed inside a columnar (diameter of its cross section: 15 μm) first refractive index region (sea portion) composed of an ethylene propylene copolymer.

With the use of these long fibers, a light diffusing film with a thickness of 150 μm was prepared in the same manner as in Example 1. The average refractive index of each component and the diffusing characteristics of the thus prepared light diffusing film were as shown in Table 1.

TABLE 1

| | Average | Average | | |
|---|---|---|---|---|
| | Refractive | Refractive | | |
| | Index n_{A} of | Index n_{B} of | Light Diffusing Film | |
| | Translucent Resin | very short fibers | Haze | Backscattering |
| Example 1 | 1.48 | 1.54 | 80% | Large |
| Example 2 | 1.48 | Sea | 80% | Small |
| | | portion = 1.50 | | |
| | | Island | | |
| | | portion = 1.54 | | |

Sea portion = First refractive index region
Island portion = Second refractive index region

### [Assessment]

Comparing the light diffusing film (Example 1) whose very short fibers are single structured to the sea-island structured light diffusing film (Example 2), the film of Example 2 is more superior as a light diffusing film because the haze of both films is equivalent, however, the sea-island structured film has less backscattering. In Example 2, the average refractive index (1.50) of the sea portion of the very short fibers is a value intermediate between the average refractive index (1.54) of the island portion and the average refractive index (1.48) of the translucent resin, so that backscattering becomes smaller.

### [Measuring Method]

### [Haze]

Haze was measured using a haze meter (produced by MURAKAMI COLOR RESEARCH LABORATORY, product name: “HM-150” in accordance with JIS K 7136:2000.

### [Average Refractive Index of Fibers]

A refractive index at room temperature (25° C.) and at the wavelengths of 546 nm was measured by the Becke's line method using a polarization microscope produced by Olympus Corporation.

### [Refractive Index of Translucent Resin]

A refractive index at room temperature (25° C.) and at the wavelengths of 546 nm was measured using a prism coupler produced by Sairon Technology Ltd.

### [Backscattering]

A black acrylic board was adhered to the back of a light diffusing film and a surface of the light diffusing film was illuminated by a white fluorescent lamp to visually observe the intensity of reflected light.

### BRIEF DESCRIPTION OF THE DRAWINGS

FIG. 1 (a) and FIG. 1 (b) are respectively a schematic view of a light diffusing film of the present invention.

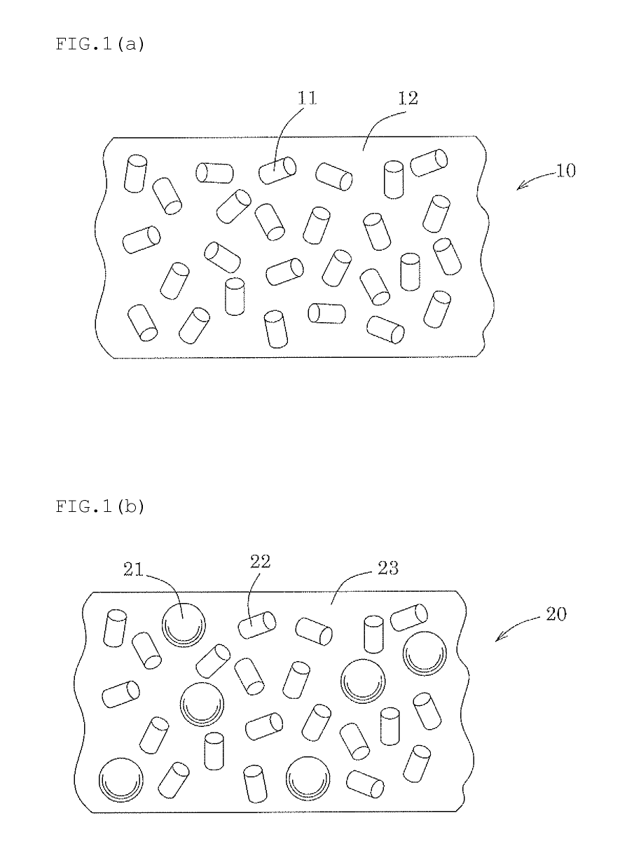

FIG. 2 (a) and FIG. 2 (b) are respectively a schematic view of very short fibers to be used in the present invention.

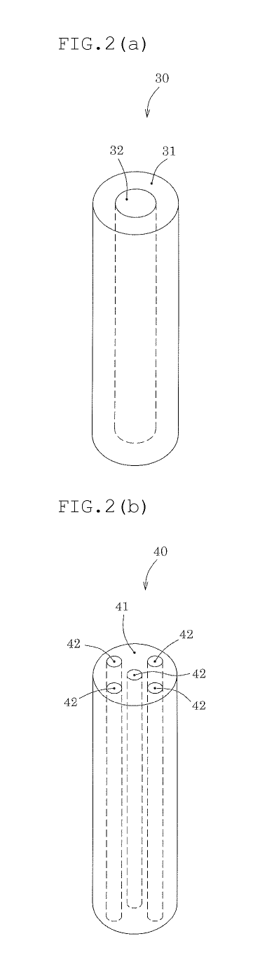

There have thus been shown and described a novel light diffusing film and a process for producing the light diffusing film, which fulfill all the objects and advantages sought therefor. Many changes, modifications, variations, combinations and other uses and applications of the subject invention will, however, become apparent to those skilled in the art after considering this specification and the accompanying drawings which disclose the preferred embodiments thereof. All such changes, modifications, variations and other uses and applications which do not depart from the spirit or scope of the invention are deemed to be covered by the invention, which is to be limited only by the claims which follow.

1. A light diffusing film comprising:
a film made of a translucent resin; and
a plurality of very short fibers dispersed in the film made of a translucent resin, wherein an average refractive index n_{A} of the translucent resin is different from an average refractive index n_{B} of the very short fibers when the average refractive index n_{A} of the translucent resin is defined as (extraordinary refractive index+2×ordinary refractive index)/3 and the average refractive index n_{B} of the very short fibers is defined as (refractive index in the direction of a major axis+2×refractive index in the direction of a minor axis)/3.

2. The film according to claim 1, wherein the average refractive index n_{A} of the translucent resin is 1.3 to 1.7 and the average refractive index n_{B} of the very short fibers is 1.4 to 1.6, and an absolute value of the difference between the average refractive index n_{A} of the translucent resin and the average refractive index n_{B} of the very short fibers, |n_{A}−n_{B}| is 0.005 to 0.15.

3. A light diffusing film comprising:
a film made of a translucent resin; and
a plurality of very short fibers dispersed in the film made of a translucent resin, each of which has a first refractive index region and a second refractive index region provided within the first refractive index region, wherein an average refractive index n_{A} of the translucent resin is different from an average refractive index n_{B2} of the very short fibers in the second refractive index region when the average refractive index n_{B2} of the very short fibers in the second refractive index region is defined as (refractive index in the direction of a major axis+2×refractive index in the direction of a minor axis)/3.

4. The film according to claim 3, wherein the average refractive index n_{A} of the translucent resin is 1.3 to 1.7 and an absolute value of the difference between the average refractive index n_{A} of the transparent resin and the average refractive index n_{B2} of the very short fibers in the second refractive index region, |n_{A}−n_{B2}| is 0.01 to 0.15.

5. The film according to claim 3, wherein the average refractive index n_{A} of the translucent resin, an average refractive index n_{B1} of the very short fibers in the first refractive index region, and the average refractive index n_{B2} of the very short fibers in the second refractive index region satisfies the relationship: n_{A}<n_{B1}<n_{B2} or n_{B2}<n_{B1}<n_{A} when the average refractive index n_{B1} of the very short fibers in the first refractive index region is defined as (refractive index in the direction of a major axis+2×refractive index in the direction of a minor axis)/3.

6. The film according to claim 1, comprising: a film made of a translucent resin; a plurality of very short fibers dispersed in the film made of a translucent resin; and a plurality of spherical fine particles dispersed in the film made of a translucent resin,
wherein an average refractive index of the translucent resin is different from an average refractive index of the very short fibers and a refractive index of the spherical fine particles.

7. (canceled)

8. The film according to claim 2, comprising: a film made of a translucent resin; a plurality of very short fibers dispersed in the film made of a translucent resin; and a plurality of spherical fine particles dispersed in the film made of a translucent resin,
wherein an average refractive index of the translucent resin is different from an average refractive index of the very short fibers and a refractive index of the spherical fine particles.

9. A process for producing the light diffusing film according to any one of claims 1 to 6 and 8, comprising the steps of:
A) dispersing a plurality of very short fibers obtained by cutting fibers in a liquid material which forms a film made of a translucent resin to obtain a dispersion liquid; and
B) casting the dispersion liquid obtained in the step A in a film and solidifying or curing a cast layer thereof to obtain a light diffusing film.
